(19) United States
(12) Patent Application Publication
(10) Pub. No.: US 2019/0342650 A1
(43) Pub. Date: Nov. 7, 2019

(54) CONTROL DEVICE FOR A HEADSET AUDIO SYSTEM AND HEADSET AUDIO SYSTEM

(71) Applicant: Plantronics, Inc., Santa Cruz, CA (US)

(72) Inventor: Matthew Nicholas Villarreal, Santa Cruz, CA (US)

(73) Assignee: Plantronics, Inc., Santa Cruz, CA (US)

(21) Appl. No.: 15/970,800

(22) Filed: May 3, 2018

(51) Int. Cl. H04R 1/10; H01R 31/06; H04R 3/00

(52) U.S. Cl. CPC H04R 1/1041; H04R 3/007; H01R 31/06

(57) ABSTRACT

A control device for a headset audio system and a headset audio system with a control device is disclosed. The headset is configured to provide output audio to a user. The control device is configured for connection with the headset. The control device comprises a cylindrical connector section for connection to an audio output socket of an audio unit; the connector section having a longitudinal axis and a control section, which is mounted to the connector section. The control section comprises at least a volume control for the output audio. The control device is configured to, during use, mechanically lock with the audio unit, so that the control device maintains a fixed angular position with respect to the audio unit around the longitudinal axis.

### TECHNICAL FIELD

The present invention relates to the field of headphones and headsets.

### BACKGROUND

Headsets are being used increasingly in computing applications, such as for teleconferencing, for electronic gaming, or as a human interface device (HID) to interact with a computing device in general. In many applications, a control of the audio parameters, such as in particular volume, is necessary or at least desired. For this purpose, software-based controls exist that allow to set audio parameters using the user interface of the respectively connected computing device. Additionally, headphones exist that comprise “in-line controls”. Typically, these types of controls consist of a small control unit that is connected in-line with the cable connection between headphone and a headphone connector so that the control unit hangs close to the user's chest when wearing the headset.

In the above-mentioned example of electronic gaming applications, both types of controls have disadvantages. A software-based control typically requires the user to pause the game, set the audio parameters as desired and then un-pause to continue playing. However, the user during the pause may experience a different audio situation, compared to the situation during the game, since typically, the game sound is muted in a pause. This may require multiple “iterations” of setting the audio parameters, which generally is tedious and distracting.

The above-mentioned in-line control on the other hand typically requires the user to let go of the game controller at least with one hand, which, even if only for a brief moment, may be distracting. Both current options are thus disadvantageous.

As the present inventor has ascertained, current control options are insufficient, in particular for gaming applications that involve a game controller.

Accordingly, an object exists to provide an improved control device for a headset audio system and a corresponding headset audio system, for example for use in video game applications.

### SUMMARY

The following summary of the present invention is provided to facilitate an understanding of some of the innovative features unique to the present invention and is not intended to be a full description. A full appreciation of the various aspects of the invention can be gained by taking the entire specification, claims, drawings, and abstract as a whole.

According to one aspect of the present invention, a control device for a headset audio system is provided, wherein the headset audio system is configured to provide output audio to a user. The control device comprises at least a cylindrical connector section for connection to an audio output socket of an audio unit, and a control section. The connector section has a longitudinal axis. The control section is mounted to the connector section and comprises at least a volume control for the output audio. The control device is configured for connection with a headset. The control device further is configured to, during use, mechanically lock with the audio unit, so that the control device maintains a fixed angular position with respect to the audio unit around the longitudinal axis.

The basic idea of this aspect of the present invention is to provide a control device with a cylindrical connector section and a control section, mounted to the connector section. The control section thus is conveniently located near the connector section and consequently, during use, near the audio output socket of the audio unit. This setup is particularly beneficial in the field of electronic gaming, where a game controller comprises an audio output socket. Here, the control section during use is close to the controls of the game controller and can be easily controlled by the user during gaming. Certainly, the present invention is not limited to the field of electronic gaming, nor to electronic game controllers.

The above aspect and other aspects of the invention will be apparent from and elucidated with reference to the embodiments described hereinafter.

### BRIEF DESCRIPTION OF THE DRAWINGS

In the drawings,

FIG. 1 shows a first embodiment of a control device in a schematic side elevation view;

FIG. 2 shows the embodiment of FIG. 1 in a schematic perspective view;

FIG. 3 shows the embodiment of FIG. 1 in a schematic front view in direction of a longitudinal axis;

FIG. 4 shows an embodiment of a headset system comprising a control device and a headset in a schematic view;

FIGS. 5A and 5B show detailed schematic views of a control device with a replaceable locking adaptor according to the embodiment of FIG. 4;

FIGS. 6A-6D show a further embodiment of a control device with multiple replaceable locking adaptors in schematic views; and

FIG. 7 shows a perspective schematic view of the embodiment of FIG. 6, connected with an audio unit.

### DETAILED DESCRIPTION OF PREFERRED EMBODIMENTS

Technical features described in this application can be used to construct various embodiments of control devices for headset audio systems and corresponding headset audio systems. Some embodiments of the invention are discussed so as to enable one skilled in the art to make and use the invention.

In a first exemplary aspect, a control device for a headset audio system is provided, comprising at least a cylindrical connector section for connection to an audio output socket of an audio unit, and a control section with at least a volume control, which control section is mounted to the connector section.

The control device of the present exemplary aspect may be of any suitable type for a connection to the audio output socket of the audio unit on one hand and a connection to the headset on the other hand. The control device may be an active device, i.e., comprising or connectable to a power supply, or a passive device, i.e., non-powered, in corresponding embodiments.

The connection to the audio device is established, during use, by the cylindrical connector section, which in corresponding embodiments is adapted for connection to the audio output socket of the respective audio unit. In one embodiment, the cylindrical connector section comprises a typical phone connector for connection to a corresponding phone connector socket on the side of the audio unit. For example, the phone connector may be a 6.35 mm, a 3.5 mm (“mini phone”), or a 2.5 mm phone connector jack/plug. It is noted, that the term “phone connector” is interchangeably used with “headphone jack” and “phone plug” herein.

The connection to the headset may be provided by any suitable headset connection that is configured to allow at least the provision of output audio to a user during use, i.e., when connected. For example, the control device may comprise a cable “pigtail”, so that the control device is permanently connectable with the headset. Alternatively, the control device may comprise a headset connector for removable connection to the headset. In one example, the headset connector is a phone connector socket, such as a 3.5 mm phone connector socket. In an alternative example, the headset connector is a phone connector plug/jack, such as a 3.5 mm phone connector jack. In yet another embodiment, the control device is configured for wireless connection to the headset, e.g., using a corresponding wireless communications interface as a headset connector. Suitable wireless transmission protocols include Bluetooth, DECT, Wi-Fi, IrDA, among other options. All of the aforementioned embodiments are in the following referred to as “headset connection”, “headset connector”, or simply as a connection to the headset.

In the context of this application, the term “headset” comprises all types of headsets, headphones, and other head-worn audio playback devices, such as for example circumaural and supra-aural headphones, ear buds, in-ear headphones, and other types of earphones. The headset can be of mono, stereo, or multichannel setup.

The headset is adapted to provide output audio to a user. The headset may be of any suitable type and may in corresponding embodiments comprise one or more drivers/earphones to provide said output audio. The headset in further embodiments certainly may comprise additional components. For example, the headset in one exemplary embodiment may comprise one or more of a microphone to obtain user input audio from the user, control electronics to process audio, a wireless communications interface, a housing, user controls, and a battery.

In the context of the present discussion, an audio unit is understood as any suitable device having an audio output socket to provide an audio signal. In corresponding embodiments, the audio unit may be a computer, tablet, smart phone, mobile gaming device, digital media player, video game console system, or other type of computing device. In another embodiment, the control device is connectable to a detachable playback device of said audio unit, such as a remote control. In case the audio unit is a video game console system, the control device, e.g., may be connectable to a wired (conductor-based) or wireless game controller of said game console. In another exemplary embodiment, the audio unit is a game controller and in particular a wireless game controller. Certainly, the audio unit in addition may in a corresponding embodiment be configured to receive an audio signal, for example a user input audio signal, obtained from a microphone of the headset.

As discussed in the preceding, the connection to the audio unit is established, during use, by the cylindrical connector section, which in corresponding embodiments is adapted for connection to the audio output socket of the respective audio unit. In the context of the cylindrical connector section, the term “connection” is understood as a mechanical connection and an electric, i.e., galvanic or conductor-based, connection. The electric connection serves, when connected with the audio unit, to transmit at least one audio signal between audio unit and control device.

Certainly, and in corresponding embodiments, the cylindrical connector section may be configured for transmission of multiple audio signals between the audio unit and the control device. For example, the cylindrical connector section may in an embodiment be configured for reception of a stereo audio signal, i.e., two audio signals, from the audio unit. This stereo signal may, in another embodiment, be passed to headset to provide corresponding output audio to the user after passing the control section for volume control.

In another additional or alternative embodiment, the connector section is configured to provide a user input audio signal to the audio unit, which user input audio signal is received from, e.g., a microphone of the connected headset.

In the context of the present discussion, the term “audio signal” and is understood to comprise any type of signal representation of audio. An audio signal may correspondingly be analog or digital. For example, the audio signals described herein may be of pulse code modulated (PCM) type, or any other type of bit stream signal. Each audio signal may comprise one channel (mono signal), two channels (stereo signal), or more than two channels (multichannel signal). Certainly, in case of multiple audio signals, a combination of the same or different types of signals is conceivable in corresponding embodiments. An audio signal may, for example, comprise a representation of music, sounds, and/or speech/chat.

The term “output audio” refers to the sound, provided to the user when wearing the headset during use of the system.

As discussed in the preceding, the control section according to the present exemplary aspect comprises at least a volume control for the output audio. The volume control may be of any suitable type for controlling the output audio. For example, the volume control may be a fader or slider, i.e., a linear control. Alternatively, the volume control may be a rotary control, dial, or rotary encoder. The respective control may be of any suitable type including analog (stepless) and digital controls. In the present context, the term “volume” of said output audio refers to the maximum sound pressure level (SPL) of said output audio, which is provided by the respective signal.

In another additional or alternative embodiment, the volume control comprises a visual and/or haptic setting indicator, so that the setting of the volume can be determined by the user easily. The present embodiment is particularly useful in electronic gaming applications since an adjustment of the respective control is possible without substantial distraction from the game play. The setting indicator in one embodiment may comprise a marking on an analog control to show a relative setting. In another embodiment, such as when using a “digital rotary control”, i.e. controls, that rotate continuously and having no mechanical stop, the setting indicator may be of electronic type, e.g., using an LED to show the setting of the respective audio parameter. In another embodiment, an onscreen indication of the respective setting is provided.

Certainly, the control section may comprise additional controls. For example, the control section may comprise one or more of a mute control, a tone/equalizer control, a balance control, and a user audio/microphone volume control. These additional controls may be provided as switch/button controls, linear controls, and/or rotary controls or dials. In one embodiment, one or more switch controls are arranged on a first end surface of the control section, which first end surface is arranged perpendicular to the longitudinal axis and opposite to a second end surface of the control section, which second end surface is arranged adjacent to the connector section.

The control section and in particular the volume control may in an embodiment be electrically connected to the connector section and/or the headset connector. In one embodiment, the control section is configured to receive one or more audio signals from the connector section and to provide the volume-controlled audio signal(s) to the headset connector, i.e., the at least one audio signal, received from the audio unit during use, is processed by the control section before being provided to the connected headset.

According to the preceding discussion, the control section is mounted to the cylindrical connector section. The control section may be mounted to the cylindrical connector section directly or indirectly, i.e., in the latter case over a suitable intermediate section or component. In one embodiment, a mechanical connection between connector section and control section is substantially rigid/torque-proof at least when typical user forces are applied. In another alternative or additional embodiment, the connector section is configured as a support member, so that during use, the control section is supported predominantly by the connector section.

In one further additional or alternative embodiment, the control section is mounted axially to the cylindrical connector section, e.g., adjacent to the cylindrical connector section and arranged along the longitudinal axis of the connector section. For example, the control section may be mounted to a base end of the connector section that is opposite to a connector section tip, the latter of which is inserted first into the audio output socket of the audio unit.

In another alternative or additional embodiment, the control section is formed integrally with the cylindrical connector section, which provides a particularly compact setup.

According to the present exemplary aspect, the control device is configured so that, during use of the control device with an audio unit, the control device mechanically locks with the audio unit, i.e., the control device maintains a fixed angular position with respect to the audio unit around the longitudinal axis. As will be apparent, the control device, once the cylindrical connector section is connected to the audio output socket of the audio unit, thus stays safely in place, so that at least no substantial angular displacement occurs when typical forces of the user are exerted on the control device and/or the audio unit. This setup provides that the volume control stays positioned with respect to the audio unit and thus facilitates user control of the volume.

As discussed in the preceding, the control device according to the present exemplary aspect comprises at least the cylindrical connector section and the control section. The control device certainly may comprise further components or sections. For example, the control device may comprise one or more or an audio processor, such as in particular a digital sound processor (DSP), logic circuitry, battery, and a housing formed of at least the connector section and the control section.

As discussed in the preceding, the volume control may be a rotary control in one embodiment. According to another embodiment, the rotary control has an axis of rotation that is parallel to or corresponds to the longitudinal axis of the cylindrical connector section. In the embodiment of a parallel arrangement of the axis of rotation of the rotary control with the longitudinal axis, a setup with a corresponding offset results. Certainly, no offset is present in the above example of the axis of rotation of the rotary control corresponding to the longitudinal axis of the cylindrical connector section, i.e., where the axes are identical.

In another embodiment, the control device further comprises at least one locking adaptor. The locking adaptor in this embodiment is configured to mechanically lock the control device with the audio unit during use, so that the control device maintains the fixed angular position, as discussed in the preceding. This locking is particularly beneficial when a rotary volume control is used, as the control device maintains its angular position around the longitudinal axis, even when the control is operated and thus when a torque is applied by the user.

The locking adaptor may be of any suitable type and may, e.g., consist of one or more of rubber, metal, and polymeric materials. In one embodiment, the locking adaptor is configured for positive (mechanical) engagement with the audio unit, e.g., with a housing section of the audio unit, close to the audio output socket. In the current discussion, the term “positive engagement” is understood in the mechanical engineering sense, namely a positive mechanical engagement.

In another embodiment, the locking adaptor is a locking adaptor sleeve. In one example, the sleeve may comprise a central through-bore, so that the sleeve can be pushed onto the cylindrical connector section.

In another alternative or additional embodiment, the locking adaptor is a replaceable locking adapter and is configured for removable connection with the control section of the control device. The present embodiment allows the user to exchange the locking adapter, for example when the control device is used with multiple, different audio units, so that the user can chose a locking adapter that allows a positive engagement with the respectively used audio unit.

The connection of the locking adaptor with the control section may be of any suitable type. In one embodiment, the control section of the control device comprises a latching device for removable connection with the locking adaptor. For example, the latching device may be groove or a notch that is provided on an outer surface of the control section. In the latter example, the locking adaptor may comprise a protrusion, configured for latching engagement with the groove/notch. The latching device in another alternative or additional embodiment may be configured so that the locking adaptor maintains a fixed angular position with respect to the control section around the longitudinal axis.

In another alternative or additional embodiment, the control section comprises a cylindrically-shaped housing with an outer circumferential surface. In this embodiment, the locking adaptor may additionally be configured for engagement with the outer circumferential surface. For example, the locking adaptor may be a locking adaptor sleeve, e.g., a cylindrically-shaped sleeve with a section having an inner diameter, that matches the diameter of the cylindrically-shaped housing of the control section at least substantially. In another example, the outer circumferential surface may comprise the aforementioned latching device or groove/notch, in which a corresponding protrusion of the locking adaptor engages upon connection.

As discussed in the preceding, a replaceable locking adapter may allow a user to exchange the locking adaptor, for example, when the control device is used with multiple, different audio units. In one additional embodiment, the control device comprises at least a first replaceable locking adaptor and a second replaceable locking adaptor, i.e., a set of replaceable locking adaptors. In this embodiment, the first locking adaptor is configured to mechanically lock the control device with a first audio unit and the second locking adaptor is configured to mechanically lock the control device with a second audio unit. The first and second locking adaptors are shaped differently from each other to allow a positive engagement with each of the differently shaped audio units. Certainly, more than two locking adaptors may be provided in corresponding embodiments.

As will be apparent from the above, the present embodiment allows the user to exchange the locking adaptors depending on which audio unit currently is used. This may particularly be beneficial in gaming applications, where users may have multiple different gaming console systems and thus differing game controllers, which in one embodiment may be the audio units. Certainly, the present embodiment is not limited to gaming applications or gaming console systems. In addition and in corresponding embodiments, more than two locking adaptors may be provided in a set together with the control device to further increase the versatility of the present control device.

In another alternative or additional embodiment, the control section comprises an acoustic safety limiter to limit the volume of the output audio to a predefined volume level. The acoustic safety limiter may be of any suitable type to limit the volume of the output audio. In one embodiment, the acoustic safety limiter is an electronic limiter, e.g. an acoustic limiter integrated circuit, configured with a predefined volume threshold. For example, the acoustic safety limiter may be configured to limit the volume of the output audio to 118 dB SPL.

In another embodiment, the acoustic safety limiter may be configured to limit the operation of the volume control. For example, the acoustic safety limiter may be a mechanical or electrical stop that hinders higher volume settings. The present embodiment is particularly cost effective.

In an additional embodiment, the acoustic safety limiter configured for disengagement by a user. For example, a button control, may be provided that allows to disengage or override the acoustic safety limiter. The button control may be arranged so that a user can easily disengage or that only an administrator, such as a parent in gaming applications, can disengage or override the acoustic safety limiter. In another embodiment, the acoustic safety limiter may be disengaged or overridden by exerting an increased force on the control. This embodiment may be particularly useful when the acoustic safety limiter is a mechanical stop.

In another aspect of the invention, a headset audio system is provided, which is configured to provide output audio to a user. The headset audio system comprises at least a headset and a control device. The control device comprises a cylindrical connector section for connection to an audio output socket of an audio unit, the connector section having a longitudinal axis, and a control section, mounted to the connector section. The control section comprises at least a volume control for the output audio. The control device is connected with the headset and is configured to, during use, mechanically lock with the audio unit, so that the control device maintains a fixed angular position with respect to the audio unit around the longitudinal axis.

The headset system and in particular the control device according to the present aspect and in further embodiments may be configured according to one or more of the embodiments, discussed in the preceding with reference to the preceding aspect. With respect to the terms used for the description of the present aspect and their definitions, reference is made to the discussion of the preceding aspect.

In yet another aspect of the invention, a headset audio system, comprising at least a headset to provide output audio to a user, a control device, connected with the headset, an audio unit with at least an audio output socket is provided. According to this aspect, the control device comprises a cylindrical connector section for connection to the audio output socket of the audio unit, and a control section, mounted to the connector section. The cylindrical connector section has a longitudinal axis and the control section comprises at least a volume control for the output audio. Furthermore, the control device is configured to, during use, mechanically lock with the audio unit, so that the control device maintains a fixed angular position with respect to the audio unit around the longitudinal axis.

The headset system and in particular the control device according to the present aspect and in further embodiments may be configured according to one or more of the embodiments, discussed in the preceding with reference to the preceding aspects. With respect to the terms used for the description of the present aspect and their definitions, reference is made to the discussion of the preceding aspects.

Reference will now be made to the drawings in which the various elements of embodiments will be given numerical designations and in which further embodiments will be discussed.

Specific references to components, sections, parts, process steps, and other elements are not intended to be limiting. Further, it is understood that like parts bear the same reference numerals, when referring to alternate figures. It is further noted that the figures are schematic and provided for guidance to the skilled reader and are not necessarily drawn to scale. Rather, the various drawing scales, aspect ratios, and numbers of components shown in the figures may be purposely distorted to make certain features or relationships easier to understand.

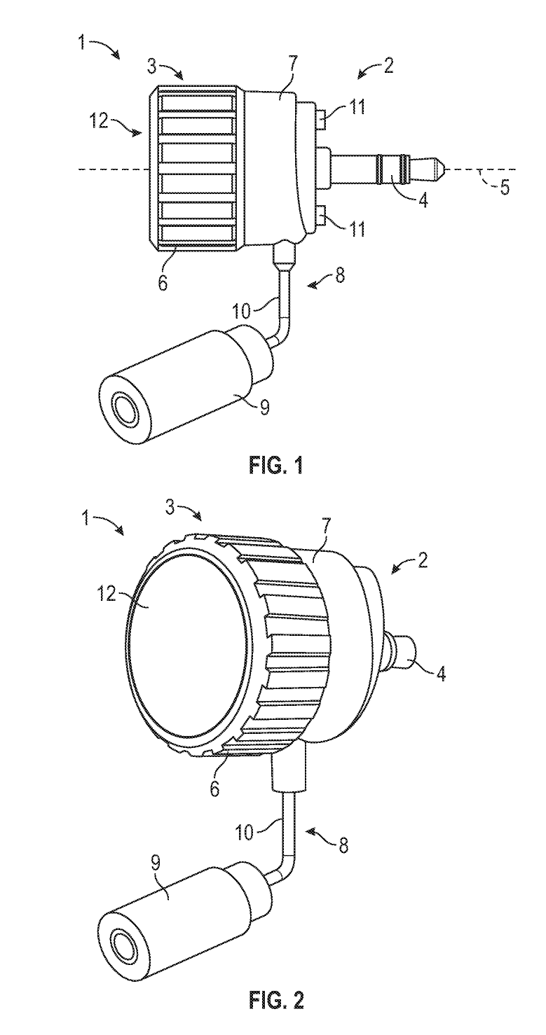

FIG. 1 shows a first embodiment of a control device 1 for a headset audio system in a schematic side elevation view. The control device 1 comprises a housing with a cylindrical connector section 2 and a cylindrical control section 3. As will be apparent from FIG. 1, the connector section 2 comprises a cylindrical phone connector 4, which in this embodiment is a stereo 3.5 mm phone connector (jack) with left channel, right channel, and ground contacts. The phone connector 4 defines a longitudinal axis 5, which in this embodiment corresponds to the axis of symmetry of the connector section 2 and the control section 3. The phone connector 4 is connectable to a corresponding audio output socket of an audio unit 50, 51 (both not shown in FIG. 1). When connected to the audio output socket, the phone connector 4 is arranged to receive a stereo analog audio signal from the audio unit 50, 51. This stereo signal is provided to the control section 3 of the control device 1 for volume control and then to a connected headset 41 (not shown in FIG. 1) of the headset audio system to provide output audio to a user, wearing the headset 41.

The cylindrical connector section 2 and in particular the phone connector 4 is mounted to the control section 3. The control section 3 comprises a cylindrical housing 7 and a rotary volume control 6, provided as an axial ring or sleeve. The volume control 6 allows a user to set the volume of the output audio, i.e., the maximum sound pressure level (SPL) of said output audio. As will be apparent from the drawing, the axis of rotation of the rotary volume control 6 corresponds to the longitudinal axis 5 of the phone connector 4, resulting in a compact setup of the device. The volume control 6 in this embodiment comprises a typical, audio-grade stereo potentiometer, connected in series between the phone connector 4 and a headset connector 8.

Volume control 6 comprises an acoustic safety limiter, namely a mechanical stop that hinders higher volume settings. The acoustic safety limiter, i.e., the mechanical stop, may be disengaged by exerting an increased force on the volume control 6. The acoustic safety limiter may be configured to limit the volume of the output audio to 118 dB SPL.

Headset connector 8 comprises a 3.5 mm headset socket 9, which is connected to the control section 3 by a short cable connection 10. Headset socket 9 in this embodiment corresponds to the phone connector 4, allowing the control device 1 to be connected in line “between” headset and audio unit 50, 51.

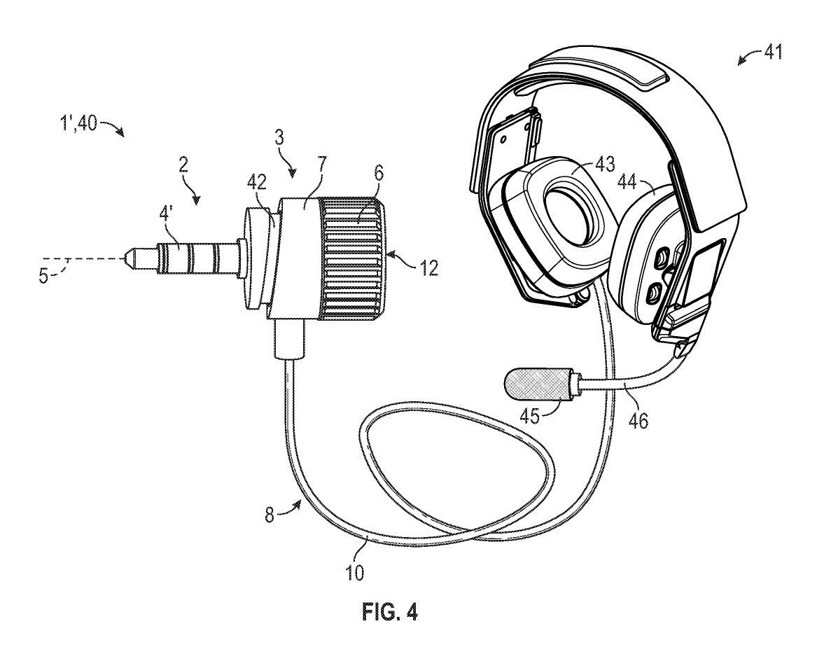

The control section 3 further comprises locking protrusions 11, as will be discussed in more detail in the following with reference to FIG. 3, and a mute control 12. The mute control 12 is a switch/push button control and is arranged on an a first axial end of the control section 3, which is opposite to the phone connector 4 along the longitudinal axis 5. In the present context, the term “axial end” refers to an arrangement in a plane, which is substantially perpendicular to the longitudinal axis 5.

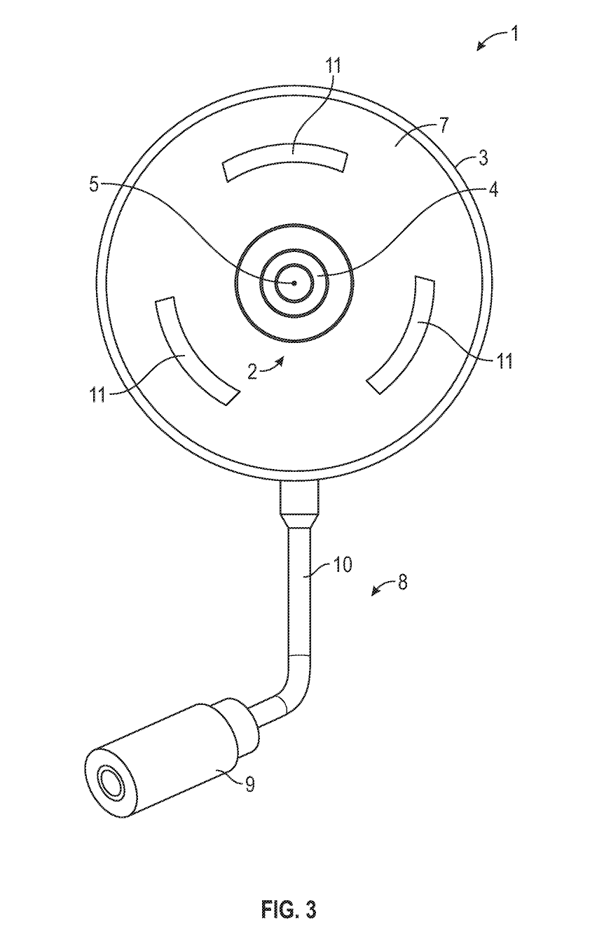

FIG. 2 shows the embodiment of FIG. 1 in a perspective view and in particular shows the arrangement of mute control 12 on the first axial end of the control section 3.

FIG. 3 shows the embodiment of FIG. 1 in a schematic frontal view, facing the phone connector 4 with a viewing direction that corresponds to longitudinal axis 5. FIG. 3 shows the locking protrusions 11, which in the present embodiment are arc-shaped protrusions, made of rubber material. These arc-shaped locking protrusions 11 come in contact with the audio unit 50, 51 (not shown in FIG. 3) when the phone connector 4 is inserted into the audio output socket (also not shown in FIG. 3) of the audio device 50, 51. The locking protrusions 11 lock the control device 1 with the audio unit 50, 51 to hinder rotational movement, i.e., to keep the control device 1 in a fixed angular position with respect to the audio unit 50, 51 around longitudinal axis 5. This arrangement provides that upon a user operating the rotary volume control 6, the position of the control device 1 remains fixed. Given the cylindrical shape of phone connector 4, a user may otherwise rotate the entire control device 1 when trying to operate the volume control 6. Accordingly, the setup of facilitates volume control, in particular for one-handed or “single-finger” operation.

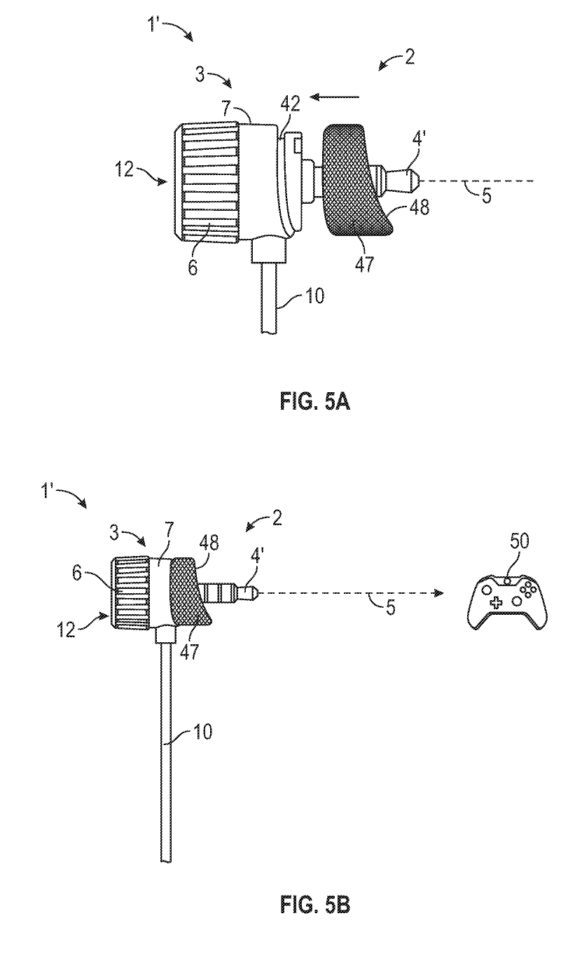

FIG. 4 shows a further embodiment of a control device 1′ in headset system 40, i.e., together with a headset 41. Headset 41 in the present embodiment comprises two earphone housings 43, 44 with corresponding drivers (not shown) to provide the output audio to the user. Microphone 45 is mounted on boom 46 to record user input audio, for example, for recording game chat audio.

The control device 1′ of the embodiment of FIG. 4 corresponds to the embodiment of FIGS. 1-3 with the following exceptions. Headset connector 8 in the present embodiment consists of a cable connection 10 to headset 41, resulting in a permanent connection between control device 1′ and headset 41. In addition, the phone connector 4′ is configured to receive a stereo analog audio signal from the audio unit 50, 51 (not shown in FIG. 4) and also to provide a user input audio signal to the audio unit 50, 51, which user input audio signal is received from a microphone 45 of the connected headset 41.

Furthermore, and instead of locking protrusions 11 being arranged on the control section 3, the housing 7 of control section 3 in this embodiment is configured with locking groove 42 on a circumferential surface. The locking groove 42 during use engages with a replaceable locking adaptor sleeve 47, as will be discussed in more detail with reference to the following figures.

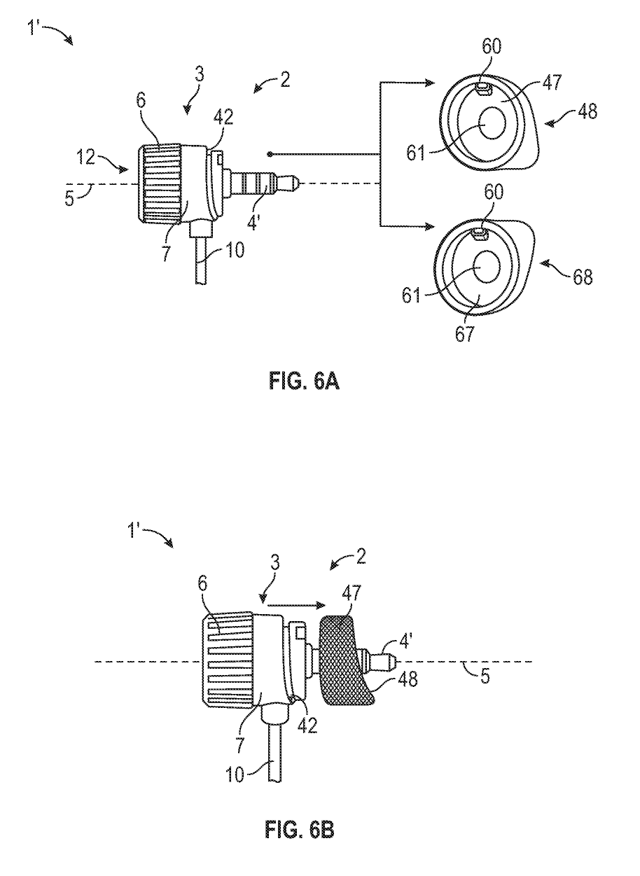

FIGS. 5A and 5B show detailed views of the control device 1′ according to the embodiment of FIG. 4 with the replaceable locking adaptor sleeve 47. As will become apparent from the drawings, locking adaptor sleeve 47 has an irregular shape, which is formed to fit audio device 50. More precisely, a front face 48 of the replaceable locking adaptor sleeve 47 is configured for positive engagement with the audio device 50, which in the present embodiment is a wireless game console controller.

Replaceable locking adaptor sleeve 47 comprises a central opening 61 (not shown in FIGS. 5A and 5B), which in use is arranged along the longitudinal axis 5, so as to allow sliding the replaceable locking adaptor sleeve 47 onto the cylindrical phone connector 4′ and the housing 7 of the control section 3 in the direction of the arrow in FIG. 5A. The replaceable locking adaptor sleeve 47 further comprises a protrusion 60 (not shown in FIGS. 5A and 5B), which engages with locking groove 42 when the replaceable locking adaptor sleeve 47 is in place, as shown in FIG. 5B. The replaceable locking adaptor sleeve 47 in this embodiment consists of natural or synthetic rubber and results in a certain elasticity of the sleeve 47 to easily engage with locking groove 42 and the housing 7 of control section 3. Due to the slightly angled arrangement of locking groove 42, i.e., in a plane, perpendicular to the longitudinal axis 5, the replaceable locking adaptor sleeve 47 maintains a fixed angular position with respect to the control section 3 when the protrusion 60 is engaged in groove 42. Accordingly, the connection between replaceable locking adaptor sleeve 47 and control section 3 is substantially “torque-proof”, at least when typical user forces are applied.

Once the replaceable locking adaptor sleeve 47 is duly in place and locked with control section 3, control device 1′ can be connected with audio unit 50. The connection between control device 1′ and audio unit 50 also is substantially “torque-proof”, at least when typical user forces are applied, so that the control device 1′ maintains its angular position when the volume control 6 is operated.

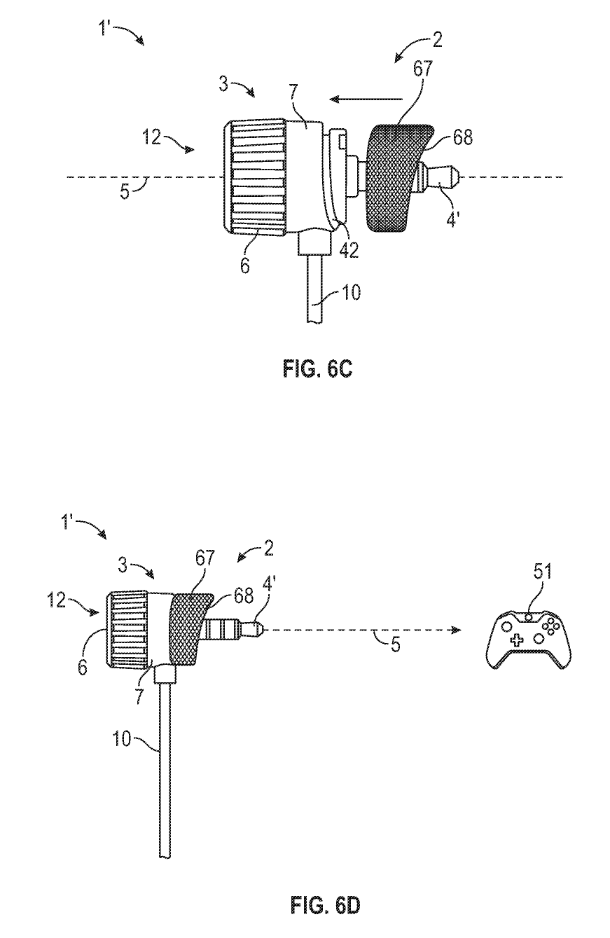

The configuration of control section 3 with the locking groove 42 allows to provide multiple replaceable locking adaptor sleeves, i.e., a set of sleeves. FIGS. 6A-6D show a further embodiment of control device 1′ with multiple replaceable locking adaptor sleeves 47 and 67.

As will become apparent from FIG. 6A, besides replaceable locking adaptor sleeve 47, a replaceable locking adaptor sleeve 67 is provided. While the shown “interior” configuration, i.e., protrusion 60 and through-hole 61 of both replaceable locking adaptor sleeves 47 and 67 is identical, so as to fit the control section 2 and the phone connector 4′, front face 68 of replaceable locking adaptor sleeve 67 is formed differently than front face 48 of replaceable locking adaptor sleeve 47. This difference provides that replaceable locking adaptor sleeve 47 allows a positive engagement (form fit) with audio device 50, while replaceable locking adaptor sleeve 67 allows a positive engagement (form fit) with audio device 51. While also audio device 51 is a wireless game console controller, both controllers have a different housing configuration, requiring two replaceable locking adaptor sleeves 47, 67 for locking of the control device 1′ with the respective audio device 50, 51.

FIG. 6B shows the removal of replaceable locking adaptor sleeve 47 from housing 7 in direction of the shown arrow. Corresponding to FIG. 5A, FIG. 6C shows the installation of replaceable locking adaptor sleeve 67. Once the replaceable locking adaptor sleeve 67 is duly in place and protrusion 60 has latched with locking groove 42, the control device 1′ can be connected with audio unit 51, as shown in FIG. 6D. The resulting connection again is torque-proof, as least as understood as in the context of the present explanation, discussed in the preceding.

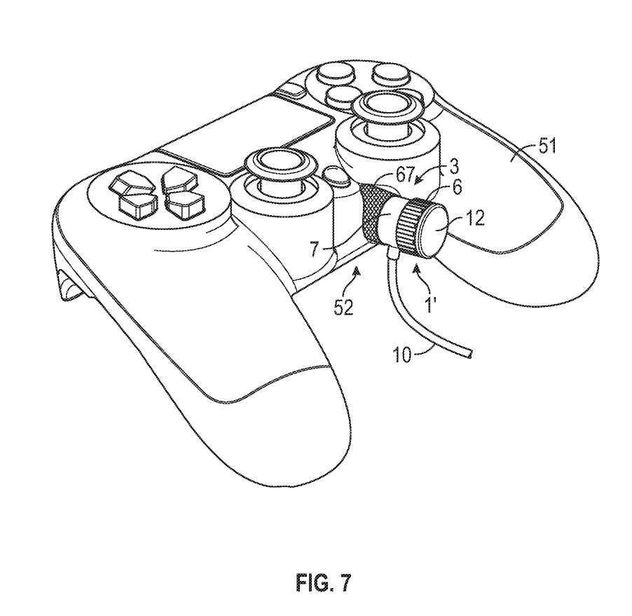

FIG. 7 shows a perspective view of control device 1′ with audio unit 51. As can be seen from the FIG., the control device 1′, due to the configuration of locking adaptor sleeve 67 is in positive engagement with housing section 52 of audio unit 51 in the vicinity of the audio output socket (not shown in FIG. 7) of the audio unit 51.

The positive engagement provides that the volume control 6 can be turned by a user, without accidentally turning the entire control device 1′. This enables a precise volume control, even when controlled with one hand or a single finder. A further advantage of control device 1, 1′ is the relatively light weight, so that the wireless controller can be handled easily, even with a connected control device 1, 1′.

While the invention has been illustrated and described in detail in the drawings and foregoing description, such illustration and description are to be considered illustrative or exemplary and not restrictive; the invention is not limited to the disclosed embodiments. For example, it is possible to operate the invention in an embodiment in which:
the control section 3 comprises a second rotary control, e.g., for balance control of the output audio;
in the embodiments of FIGS. 1-3, instead of headset socket 9, a cable pigtail is provided for a direct connection with a headset 41;
in the embodiments of FIGS. 4-7, instead of a permanent connection with headset 41, a headset socket 9 is provided;
instead of the volume control 6 having a mechanical stop as acoustic safety limiter, the control section 3 comprises an electronic limiter module, such as an ALIC; and/or
instead of analog signals, digital signals are used, and control device 1, 1′ is configured for digital volume control with a corresponding digital sound processor.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, module or other unit may fulfill the functions of several items recited in the claims.

The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

What is claimed is:

1. A control device for a headset audio system, which headset audio system is configured to provide output audio to a user, the control device comprising at least
a cylindrical connector section for connection to an audio output socket of an audio unit, the connector section having a longitudinal axis; and
a control section, mounted to the connector section; wherein
the control section comprises at least a volume control for the output audio;
the control device is configured for connection to a headset; and wherein
the control device is configured to, during use, mechanically lock with the audio unit, so that the control device maintains a fixed angular position with respect to the audio unit around the longitudinal axis.

2. The control device of claim 1, wherein the control section is arranged along the longitudinal axis.

3. The control device of claim 1, wherein the connector section comprises a phone connector.

4. The control device of claim 1, wherein the volume control is a rotary control.

5. The control device of claim 4, wherein the rotary control has an axis of rotation that is parallel to or corresponds to the longitudinal axis.

6. The control device of claim 1, wherein the connector section is configured as a support member, so that during use, the control section is connected with the audio unit predominantly by the connector section.

7. The control device of claim 1, further comprising at least one locking adaptor, which locking adaptor is configured to mechanically lock the control device with the audio unit during use, so that the control device maintains the fixed angular position.

8. The control device of claim 7, wherein the locking adaptor is configured for positive engagement with the audio unit.

9. The control device of claim 7, wherein the locking adaptor is a replaceable locking adaptor and is configured for removable connection with the control section.

10. The control device of claim 7, wherein the locking adaptor is a locking adaptor sleeve.

11. The control device of claim 10, wherein the control section comprises a cylindrically shaped housing with an outer circumferential surface and the locking adaptor sleeve is configured for engagement with the outer circumferential surface of the control section.

12. The control device of claim 9, wherein at least a first replaceable locking adaptor and a second replaceable locking adaptor are provided; the first locking adaptor being configured to mechanically lock the control device with a first audio unit; the second locking adaptor being configured to mechanically lock the control device with a second audio unit; wherein the first and second locking adaptors being shaped differently from each other.

13. The control device of claim 1, wherein the control section additionally comprises one or more switch controls.

14. The control device of claim 14, wherein the one or more switch controls are arranged on a first end surface of the control section, which first end surface is arranged perpendicular to the longitudinal axis and opposite to a second end surface of the control section, which second end surface is arranged adjacent to the connector section.

15. The control device of claim 1, further comprising a headset connector.

16. The control device of claim 1, wherein the control section comprises an acoustic safety limiter to limit the volume of the output audio to a predefined volume level.

17. Headset audio system, comprising at least
a headset to provide output audio to a user; and
a control device, connected with the headset; the control device comprising
a cylindrical connector section for connection to an audio output socket of an audio unit; the connector section having a longitudinal axis; and
a control section, mounted to the connector section; wherein
the control section comprises at least a volume control for the output audio;
and wherein
the control device is configured to, during use, mechanically lock with the audio unit, so that the control device maintains a fixed angular position with respect to the audio unit around the longitudinal axis.

18. The headset audio system of claim 18, further comprising at least one locking adaptor, which locking adaptor is configured to mechanically lock the control device with the audio unit during use, so that the control device maintains the fixed angular position around the longitudinal axis.

19. The headset audio system of claim 18, wherein at least a first replaceable locking adaptor and a second replaceable locking adaptor are provided; the first locking adaptor being configured to mechanically lock the control device with a first audio unit; the second locking adaptor being configured to mechanically lock the control device with a second audio unit; wherein the first and second locking adaptors being shaped differently from each other.

20. Headset audio system, comprising at least
a headset to provide output audio to a user;
a control device, connected with the headset; and
an audio unit with at least an audio output socket; wherein
the control device comprises
a cylindrical connector section for connection to the audio output socket of the audio unit; and
a control section, mounted to the cylindrical connector section; wherein
the cylindrical connector section has a longitudinal axis;
the control section comprises at least a volume control for the output audio; and wherein
the control device is configured to, during use, mechanically lock with the audio unit, so that the control device maintains a fixed angular position with respect to the audio unit around the longitudinal axis.
